(19) United States
(12) Patent Application Publication
(10) Pub. No.: US 2025/0252366 A1
(43) Pub. Date: Aug. 7, 2025

(54) AUTOMATED RUN-TIME WORKFLOW ASSIGNMENT SYSTEM

(71) Applicant: IC Labs, LLC, Pasadena, CA (US)

(72) Inventors: Christopher McDaniel, Pasadena, CA (US); Brian Faulkner, Pasadena, CA (US); Michael Kakehashi, Pasadena, CA (US); Lynn Phillips, Pasadena, CA (US); John Kleeman, Pasadena, CA (US)

(21) Appl. No.: 19/047,391

(22) Filed: Feb. 6, 2025

Related U.S. Application Data
(60) Provisional application No. 63/550,991, filed on Feb. 7, 2024.

(51) Int. Cl. G06Q 10/0631

(52) U.S. Cl. CPC G06Q 10/06311

(57) ABSTRACT

Aspects of the present application relate to systems and methods for generating run-time workflows and assigning employees to the workflows by identifying attributes for each workflow. The workflow assignment can include determining a master plan, processing the master plan to generate a hierarchical data structure, periodically identifying workflows based on the lowest level of the data structure, determining attributes for each workflow in each period, and determining available employees for each workflow identified at each period.

This application claims the benefit of U.S. Provisional Patent Application No. 63/550,991, titled “AUTOMATED RUN-TIME WORKFLOW ASSIGNMENT SYSTEM” filed on Feb. 7, 2024, which is hereby incorporated by reference in its entirety.

### BACKGROUND

Generally described, business administrators can manage workflow resources to operate the business more efficiently. For example, these administrators may generate and manage workflows for human resources, such as employees that are assigned to implement specific tasks, often during defined time windows. Managing these workflows can include assigning individual workflow tasks for workflows (e.g., shift schedules) to individual employees to meet business outcomes. For instance, in the context of a security monitoring service, a security patrol service provider (e.g., the business administrator of the security patrol service provider) might create a patrol plan for their clients and assign identified patrol officials based on this plan. Such workflow resources can be based on human resources, such as the number of available patrol officials.

As also generally described, computing devices and communication networks can be utilized to exchange data and/or information. In a common application, a computing device can request content from another computing device via the communication network. For example, a computing device can collect various data and utilize a software application to exchange content with a server computing device via the network (e.g., the Internet). Such software applications can include general communication applications for accessing the network, such as browser applications. Such general communication applications can access functionality provided by network-based services. The software applications can also include custom or specialized software applications configured to implement specific functionality alone or in combination with network-based services.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 depicts a block diagram of a system that includes one or more computing devices, managing devices, and an automated run-time workflow assignment system according to one or more embodiments as disclosed herein;

FIG. 2 is a block diagram of illustrative components of a workflow generation module according to one or more embodiments as disclosed herein;

FIGS. 3A and 3B are illustrative interactions of workflow generation that can be utilized in the aspects of the workflow assignment in accordance with one or more embodiments as disclosed herein; and

FIGS. 4A and 4B are flow diagrams illustrative of workflow generation routines utilizing the automated run-time workflow assignment system in accordance with one or more embodiments as disclosed herein.

### DETAILED DESCRIPTION

Aspects of the present application relate to systems and methods for generating workflow for employees by identifying the workflow resources in real time or near real time. The workflow resources can include human resources employed by a business entity. The workflow generation can include identifying workflows based on a master plan of the business. The workflow generation can also include updating the identified workflows based on one or more updated attributes. For example, if the business entity is related to providing security patrol service, the workflow resources can include the employed security patrol officials, and the master plan can be the security patrol plans for each contracted security patrol area(s) and/or structure(s). Illustratively, one or more workflows can be generated based on the master plan, such that the workflows can include security patrol posts in each area and patrol time for each post. Individual posts may be associated with geographic boundaries, identifiable landmarks, assigned physical tasks, and various combinations there. The one or more generated workflows can be updated by identifying the updated attributes of the master plan in real-time. For instance, if the number of patrol posts is changed, the previously generated workflows based on the master plan can also be updated. The attributes disclosed herein can generally refer to any attributes used to generate the workflows based on the master plan. For example, if the master plan is related to security patrolling service, the attributes can include but are not limited to the number of patrol posts, types of patrol areas, time duration of patrolling each post, number of required patrol officials, required qualification of patrol officials, and the like. Therefore, in this scenario, details such as the specific location of the patrol post, the duration of the patrol, the duties required during the patrol period, and similar aspects can be formulated into a workflow. This workflow can then be assigned to one or more patrol officers. Even though the present disclosure describes the disclosed embodiments with examples of the security patrol service, these examples are merely provided for example purposes, and the present disclosure is not limited to the security patrol service.

One or more aspects of the present disclosure relate to generating run-time workflows utilizing an automated run-time workflow assignment system. More specifically, the workflow generation system can generate run-time workflows for a certain duration of time based on the master plan. For example, the automated run-time workflow assignment system may periodically generate workflows associated with a master plan. The duration of each period can be pre-defined and/or dynamically defined based on specific applications. The present application does not limit the pre-defined duration of each period. In some embodiments, the automated run-time workflow assignment system can identify one or more employees for each workflow and assign the employees.

In some aspects of the present disclosure, the automated run-time workflow assignment system can generate workflows corresponding to a master plan. In these aspects, the automated run-time workflow assignment system can periodically verify the generated workflows. For example, the automated run-time workflow assignment system can determine whether any of the workflow requirements utilized for the master plan have been changed. For instance, the automated run-time workflow assignment system may identify one or more attributes that can cause modification of one or more workflows of the plurality of workflows (corresponding to the master plan) and update one or more workflows according to the identified one or more attributes.

In various aspects of the present disclosure, the automated run-time workflow assignment system can obtain and process data collected from various computing devices (e.g., those used by individual employees) and multiple managing devices (e.g., those used by system administrators) configured to provide workflow requirements. In some instances, a security patrol service provider might implement an automated run-time workflow assignment system. This system can collect patrol requirements from managing devices, such as computing devices utilized by a general security patrol administrator or an individual client requesting the security patrol service.

The automated run-time workflow assignment system can process data received from these managing devices, where the data includes workflow requirements. For example, the data might detail targeted security patrol areas (or structures) and specific patrol requirements, such as time slots and required capabilities for each area. Based on the processing the data, the automated run-time workflow assignment system can generate a master plan. The master plan can include a plurality of workflows that can be determined by processing the received data. In various embodiments, after determining the plurality of workflows, the automated run-time workflow assignment system can identify patrol officers who can be assigned to one or more workflows of the plurality of workflows (e.g., time slots). In some aspects of the present disclosure, one or more workflows of the plurality of workflows associated with a master plan can be updated or modified when workflow attributes are changed. For example, if the master plan is related to security patrolling service, the attributes can include but are not limited to the number of patrol posts, types of patrol areas, time duration of patrolling each post, number of required patrol officials, required qualification of patrol officials, and the like. In this example, the automated run-time workflow assignment system can monitor any changes in these attributes and update corresponding workflows based on the changes.

In some aspects, the automated run-time workflow assignment system can identify one or more employees according to the workflow and can assign the identified one or more employees to the corresponding workflows. For example, the identification of the patrol officers can be based on one or more required attributes of the security patrol service in relation to the patrol officers. For example, the attributes can be based on quantitative data, such as a level of experience, capability (e.g., capability to use weapons), patrol skills, a level of skill, and the like.

In some embodiments, the attributes can be determined based on the qualitative data. For example, the qualitative data can include but are not limited to feedback data, historical data associated with individual employee's evaluation, employee interviews and/or surveys, and the like. In these embodiments, the automated run-time workflow assignment system may identify the qualitative data and vectorize the data for individual employees. For example, if an employee performs a workflow, the feedback from the client, the employee's supervisor, and/or other peer employees can be converted into a score (e.g., confidence score), such that the positive feedback may increase the score, where the negative feedback may decrease the score. In certain instances, the automated run-time workflow assignment system might sift through the pool of identified employees using a score-based filter, applying a threshold score that varies according to the specific applications. For instance, in the context of a security patrol area demanding highly proficient officers, the required threshold score would be set higher than in zones where a less rigorous security presence suffices.

In some embodiments, the automated run-time workflow assignment system can further determine employees by further filtering based on the collective performance of each employee. In some examples, the automated run-time workflow assignment system can filter the identified employees based on collective performance data. For example, if the collective performance data indicate that certain employees had poor performance, such as these employees did not come to the work, the automated run-time workflow assignment system may exclude these employees from the pool of identified employees. In some embodiments, the automated run-time workflow assignment system can manage these employees who had poor performance record. For example, the automated run-time workflow assignment system can provide additional incentives to these employees to improve their work performance.

In certain situations, the automated run-time workflow assignment system may identify one or more employees based on each workflow. For instance, if a workflow identified from a master plan includes a task of 2:00 AM patrol of a college dormitory, the system would analyze the necessary attributes for this post (e.g., task(s)) and identify suitable patrol officers. The system could access its database to find officers available at 2:00 AM. This identification might be based on qualitative data, such as survey responses indicating a preference for working at this time, which would result in a higher score. Additionally, officers who have received positive feedback from the same client may also score higher. The identification process could also consider quantitative data like years of experience. Budget constraints could also factor into the scoring, with officers charging rates above the budget receiving lower scores. These attributes and the scoring of each attribute can be determined based on specific applications, and the present disclosure does not limit the type of attributes and their scoring mechanism for the attributes.

Illustratively, one or more aspects of the present application correspond to the utilization of one or more local devices for facilitating the generation, management and updating of workflows. The local device can be one or more computing devices and configured to provide an interface that can display available workflows by associating it with one or more attributes. For example, the interface can display available workflows by categorizing them based on the attributes such as time, distance, and required capabilities. In some illustrations, the managing device can also be the local device, and the managing device can be configured to provide workflow requirements to the automated run-time workflow assignment system. For example, the managing device implemented by a security service provider may provide targeted security patrol area(s), specific security requirements for each area, and the like.

Illustratively, one or more aspects of the present application correspond to the utilization of a network service that can implement the automated run-time workflow assignment system. The automated run-time workflow assignment system can generate processing results based on processing the data received from a plurality of computing devices and one or more managing devices. As described above, the automated run-time workflow assignment system can receive workflow data from the managing devices and determine master plan and corresponding workflows based on the master plan.

Traditionally, managing individual workflows by utilizing resources such as human resources has presented limitations in terms of efficiency. More specifically, traditional workflow generation, typically performed manually, considers only the current workflow plan and resources. In such systems, individual workflows are pre-assigned and lack the flexibility to adapt dynamically to unexpected changes in workflow requirements or staff availability. In this regard, computational incorporation of attribute data in a manual process is deficient, especially in consideration of the influence (e.g., weights) attributable to different attribute data. For example, a manual selection process is typically not able to determine a consistent balance between multiple attributes such as historical performance data, decaying feedback information, and the like. Accordingly, the influence of individual preferences or bias can be found in manual processes.

Moreover, traditional workflow generation may struggle in dynamic environments. For instance, if the workflow generation pertains to a security patrol service provider, the traditional system may not be equipped to handle individual requests from thousands of patrol officers when assigning each officer's workflow. Also, since the workflow assignments are performed by manually, unsuitable employees can be assigned to the workflow, thereby increasing the dissatisfaction for both of the employees and customers.

To address at least a portion of the deficiencies described above, one or more aspects of the present disclosure relate to systems and methods for assigning workflows for individual employees. Specifically, these systems and methods can generate a master plan and its specific workflows in real time or near real time in by processing data generated from one or more managing devices and generating the required workflows corresponding to the generated master plan.

Illustratively, an automated run-time workflow assignment system, as disclosed herein, can be communicatively coupled with multiple computing devices and one or more managing devices. In some examples, the managing devices can be used by system administrators and configured to provide workflow requirements to the automated run-time workflow assignment system.

The workflow requirements can be related to requirements for utilizing workflow resources, such as human resources, and the requirements can vary based on a specific application that implements the system. For instance, if a security patrol service provider implements the system, the workflow information can be related to, but not limited to, types of targeted security patrol areas, number of targeted security patrol areas, duration of patrolling time for each targeted patrol area, and/or patrolling requirements such as required experiences and capabilities of the patrol officials, among others. Furthermore, in this example, the workflow information can be provided as contract documents between the service providers and their clients.

In some embodiments, the automated run-time workflow assignment system obtains the workflow requirements from the managing devices and identifies specific workflow requirements. In these embodiments, the automated run-time workflow assignment system may parse the obtained workflow requirements and generate a master plan. The automated run-time workflow assignment system can also organize portions of the workflow according to a hierarchical data structure based on the master plan. For example, if the automated run-time workflow assignment system is utilized for a security patrol service provider, the hierarchical data structure can be based on a master plan for the patrolling area(s) and can include, for example, individual data nodes (or identifiable groupings of data) for specific attributes or tasks, such as a targeted security patrol building, floors, and each post included in each floor, relatively from the highest hierarchy to the lowest hierarchy of the data structure. This example is merely provided as an illustrative example, and the present disclosure is not limited to this example.

In various examples disclosed herein, the automated run-time workflow assignment system may generate a master plan based on the processed results of the workflow requirements obtained from the managing devices. The master plan can represent the workflow requirements at various levels of the data structure. In these embodiments, the automated run-time workflow assignment system can divide the master plan into one or more sub-master plans that correspond to the lowest data level of the hierarchical data structure (e.g., a hierarchical organizational structure). For example, the lowest level of the data structure, posts, can correspond to the sub-master plans. In some embodiments, the automated run-time workflow assignment system further processes these sub-master plans and determines attributes associated with each sub-master plan.

In various instances, the attributes can include quantitative attributes and qualitative attributes. The quantitative attributes, for example, can be related any attributes related to the sub-master plans that attributes are represented with numbers. For example, in an application of the automated run-time workflow assignment system for the security patrol service provider, the quantitative attributes can include but are not limited to years of experience, number of successful patrols completed, number of incidents resolved, availability of the patrol officer, location of the patrol officer, patrol officer's response time to the incident, rate of the patrol officer, and the like. The qualitative attributes can be identified based on the behavior of the employees, feedback, descriptive information about the employees, etc. For example, the qualitative attributes can include but are not limited to patrol officers' communication skills, decision-making skills, integrity, interpersonal skills, knowledge of the regulations and patrol policy, customer service skills, etc. These attributes are generally from performance reviews (or descriptions) about the specific patrol official. Additionally, the qualitative attributes can also include the patrol officer's own feedback, opinion, and/or survey results. These quantitative and qualitative attributes are determined based on specific applications, and the present disclosure does not limit the types of attributes.

In some examples, one or more attributes can be updated (e.g., changed), and the workflow corresponding to these one or more attributes may need to be updated accordingly. For example, the number of required patrol post areas can be changed. According to one or more embodiments, as disclosed herein, the automated run-time workflow assignment system may monitor these workflow requirement changes and update the workflow accordingly. Illustratively, the automated run-time workflow assignment system may monitor any changes in the workflow requirement and determine whether the existing workflows need to be updated. For example, the automated run-time workflow assignment system, upon identifying the changes in the current workflow requirements, may identify corresponding workflows. Then, the automated run-time workflow assignment system can update the corresponding workflows. In some embodiments, the automated run-time workflow assignment system can update the corresponding workflows during a pre-defined duration and re-evaluate whether these corresponding workflows need to be converted into the original workflows. In alternative embodiments, the updated workflows can be permanently implemented as the workflows associated with the master plan until the automated run-time workflow assignment system identifies any change in the workflow requirements. In other embodiments, the automated run-time workflow assignment system can periodically monitor any changes in the workflow requirements and update the corresponding workflows periodically.

In some embodiments, the automated run-time workflow assignment system may identify the available employees who can work on one or more workflows. In some examples, the automated run-time workflow assignment system can access its database and identify the available employees. For example, if the automated run-time workflow assignment system is used by a security patrol service provider, the database of the automated run-time workflow assignment system may store the employed security patrol officer's information. In some embodiments, the automated run-time workflow assignment system may determine the confidence score for each employee based on the determined workflow and its attributes. For example, if the master plan is patrolling a bank building, the sub-master plan can include patrolling a security room for 24 hours with 2 hour shift. In this example, the automated run-time workflow assignment system may identify various selection attributes, such as the quantitative attributes can include each office with at least 5 years of security patrol experience, more than 95% of successfully completed patrols, having a license to use the pistol, having a zero crime record, located within 5 miles from the bank building, and/or with an hourly rate less than $200. Further, in this example, the qualitative attributes can include each officer's preference for working patrolling the security area, previous feedback on working at the bank building, knowledge of the regulation, and/or previous customer feedback.

In some embodiments, the automated run-time workflow assignment system can generate a confidence score for assigning each available employee to the available workflows associated with the sub-master plans. For example, after identifying the above attributes, the automated run-time workflow assignment system may generate a low confidence score (or filter out) for the patrol officers who do not meet the quantitative attributes. The automated run-time workflow assignment system may determine the confidence score of the remaining patrol officers based on the qualitative attributes. For example, each attribute of the qualitative attributes can have a different weight, and the confidence score can be determined based on each employee's evaluation based on the qualitative attributes. The weight of each attribute and its determination of the confidence score can be different based on the specific applications.

Although certain illustrative embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

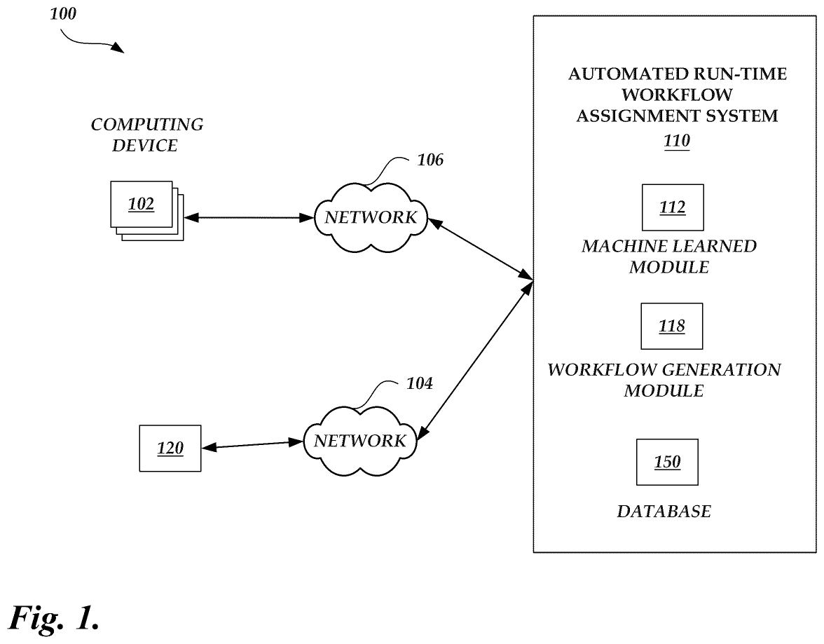

FIG. 1 depicts a block diagram of an embodiment of the system 100. The system 100 can include a network 104, the network connecting a number of managing devices 120 and the automated run-time workflow assignment system 110. The system 100 can also include network 106, the network connecting a plurality of computing devices 102, and the automated run-time workflow assignment system 110. Illustratively, the various aspects associated with the automated run-time workflow assignment system 110 can be implemented as one or more components that are associated with one or more functions or services. The components may correspond to software modules implemented or executed by one or more computing devices 102 and/or managing devices 120, which may be separate stand-alone local devices. Accordingly, the components of the automated run-time workflow assignment system 110 should be considered as a logical representation of the service, not requiring any specific implementation on the computing devices 102 and/or the managing devices 120.

Networks 104, 106 as depicted in FIG. 1, can connect the automated run-time workflow assignment system 110 and the managing devices 120 and the computing devices 120, respectively. The networks 104, 106 can comprise any combination of wired and/or wireless networks, such as one or more direct communication channels, local area networks, wide area network, personal area network, and/or the Internet, for example. In some embodiments, the communication between the automated run-time workflow assignment system 110 and the computing devices 102 and/or the managing devices 120 may be performed via a short-range communication protocol, such as Bluetooth, Bluetooth low energy (“BLE”), and/or near field communications (“NFC”).

In some embodiments, the networks 104, 106 may be a private or semi-private network, such as a corporate or university intranet. The networks 104, 106 may include one or more wireless networks, such as a Global System for Mobile Communications (GSM) network, a Code Division Multiple Access (CDMA) network, a Long Term Evolution (LTE) network, or any other type of wireless network. The networks 104, 106 can use protocols and components for communicating via the Internet or any of the other aforementioned types of networks. For example, the protocols used by the networks 104, 106 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The types of network 104 and network 106 can be the same type of network or different types of network. These types can be determined based on specific applications, and the present disclosure does not limit these types of networks.

As described in FIG. 1, the automated run-time workflow assignment system 110 can be communicatively coupled with the managing devices 120 via the network 104. The automated run-time workflow assignment system 110 can connect any number of managing devices 120. In various embodiments, each managing device 120 can be utilized by a system administrator (e.g., business operation manager, business administrator, etc.) and configured to provide workflow requirements to the automated run-time workflow assignment system. For example, if the automated run-time workflow assignment system is adapted for the security patrol service provider, the system administrator can provide one or more inputs that represent security patrol requirements, such as types of security patrol area(s), number of areas, required patrolling time, required to-do list during the patrolling, number of patrol officials, and the like. The system administrator may provide the inputs in text, contracts, certain formats, etc. In some embodiments, the managing devices 120 can be any computing device such as a desktop, laptop or tablet computer, personal computer, tablet computer, wearable computer, server, personal digital assistant (PDA), hybrid PDA/mobile phone, mobile phone, smartphone, and the like. In some embodiments, the managing devices 120 may execute an application (e.g., a browser, a stand-alone application, etc.) that allows a system administrator to access interactive user interfaces, view images, analyses, or aggregated data, and/or the like as described herein.

As described in FIG. 1, the automated run-time workflow assignment system 110 can be communicatively coupled with the computing devices 102 via the network 106. The automated run-time workflow assignment system 110 can connect any number of computing devices 102. Each computing device 102 can be utilized by an employee and can be configured to provide work related information. For example, if the automated run-time workflow assignment system is adapted for the security patrol service provider, the employee can be the patrol official. In this example, the computing device 102 may provide an interface that can display the available works for the patrol officials. This interface can be an application programming interface. In some examples, these available works can be provided with various attributes, such as distance (e.g., distance from the location of the official to the targeted patrol area), time slots, capability, compensation, and the like.

In some embodiments, the computing devices 102 can be any computing device such as a desktop, laptop or tablet computer, personal computer, tablet computer, wearable computer, server, personal digital assistant (PDA), hybrid PDA/mobile phone, mobile phone, smartphone, set top box, voice command device, digital media player, and the like. In some embodiments, the computing devices 102 may execute an application (e.g., a browser, a stand-alone application, etc.) that allows a user (e.g., an employee) to access interactive user interfaces, view images, analyses, or aggregated data, and/or the like as described herein. In various embodiments, users (e.g., employees) may interact with the automated run-time workflow assignment system via various devices. Such interactions may typically be accomplished via interactive graphical user interfaces or voice commands, however alternatively, such interactions may be accomplished via command line, and/or other means.

The automated run-time workflow assignment system 110, as shown in FIG. 1, can include a machine learned module 112, a workflow generation module 118, and database 150. The workflow generation module 118 can be configured to monitor any events that can cause updates or modifications to the existing workflows, and in response detecting the events, the workflow generation module 118 can modify the existing workflows. The events can relate to any changes on one or more attributes of workflows or attributes of the employees. The attributes of workflows can correspond to the workflow requirements. For example, if the master plan is related to security patrolling service, the attributes can include but are not limited to the number of patrol posts, types of patrol areas, time duration of patrolling each post, number of required patrol officials, required qualification of patrol officials, and the like. In some embodiments, the attributes of the employee can be determined based on the qualitative data. For example, the qualitative data can include but are not limited to feedback data, historical data associated with individual employee's evaluation, employee interview and/or survey, and the like. In these embodiments, the automated run-time workflow assignment system may identify the qualitative data and vectorize the data for individual employees. For example, if an employee performed a workflow, the feedback from the client, the employee's supervisor, and/or other peer employees can be converted into a score (e.g., confidence score), such that the positive feedback may increase the score, where the negative feedback may decrease the score. In some examples, the attributes of the employee can be based on quantitative data, such as a level of experience, capability (e.g., capability to use weapons), patrol skills, a level of skill, and the like. Thus, for example, if the event has occurred, such that the number of patrol post is increase, the workflow generation module 118 can automatically generate workflows with respect to the increased number of the patrol posts.

In some embodiments, the workflow generation module 118 can receive workflow requirements from the managing devices 120. For example, if the automated run-time workflow assignment system is implemented for a security patrol service provider, the system administrator can provide one or more inputs that represent security patrol requirements, such as types of security patrol area(s), number of areas, required patrolling time, required to-do list during the patrolling, number of patrol officials, and the like. The workflow generation module 118 may process the received workflow requirements and generate a master plan. For example, the workflow generation module 118 may process the security patrol contract(s) to determine one or more patrol requirements. In some examples, the workflow generation module 118 can process the received workflow requirements (e.g., from the managing devices) and generate a hierarchical data structure. For example, the highest level of the data structure can be a building, the lower layer can be floors, the lower layer can be rooms within the floors, and the lowest layer can be posts in each room. This example is merely provided for illustration purposes, and the types of the data structure can be determined based on specific applications.

In addition, the workflow generation module 118 can generate a master plan based on the processed result of the received workflow requirements. The master plan may include one or more required workflows for each level of the hierarchical data structure. For example, at the highest level, the master plan may provide the patrol requirements, such as the types of patrol areas, required security level, patrol time, etc. For the purpose of the description, the lowest level of the organizational structure (e.g., the lowest level represented in a corresponding data structure) can be referred to as sub-master plan. For example, in the sub-master plan, the workflow generation module 118 may process the lowest level of the data structure by associating it with the required attributes. Further, in this example, if the lowest level of the data structure corresponds to information descriptive of posts, individual posts can be represented as groupings of information (e.g., nodes) with the required patrol attributes for each post, such as the number of patrol officials, patrol time, the required capability of the patrol official, and the like.

In some examples, each area of the post can be identified by performing vectorization of information associated with a defined area that includes the posts. For example, if a floor includes a number of posts, the workflow generation module 118 may perform vectorization of the floor to identify each post area. In some examples, the post area can be provided as text format from the managing device 120, and the workflow generation module 118 can process the text format and identify the post area by associating it with the vectorized space of the area. In some instances, the machine learned module 112 can be utilized to generate the vectorized areas.

In some embodiments, the workflow generation module 118 processes these sub-master plans and determines attributes associated with each sub-master plans. In various instances, the attributes can include quantitative attributes and qualitative attributes. The quantitative attributes, for example, can be related to any attributes related to the sub-master plans that attributes are represented with numbers. For example, in an application of the automated run-time workflow assignment system for the security patrol service provider, the quantitative attributes can include but are not limited to years of experience, number of successful patrols completed, number of incidents resolved, availability of the patrol officer, location of the patrol officer, patrol officer's response time to the incident, rate of the patrol officer, and the like. The qualitative attributes can be identified based on the behavior of the employees, feedback, descriptive information about the employees, etc. For example, the qualitative attributes can include but are not limited to patrol officer's communication skills, decision-making skills, integrity, interpersonal skills, knowledge of the regulations and patrol policy, customer service skills, etc. These attributes are generally from other people's reviews (or descriptions) about the specific patrol official. Additionally, the qualitative attributes can also include the patrol officer's own feedback, opinion, and/or survey results. These quantitative and qualitative attributes are determined based on specific applications, and the present disclosure does not limit the types of attributes.

In some embodiments, the workflow generation module 118 may identify the available employees who can work on one or more sub-master plans. In some examples, the workflow generation module 118 can access its database 150 and identify the available employees. For example, if the automated run-time workflow assignment system is used by a security patrol service provider, the database 150 of the automated run-time workflow assignment system 110 may store the employed security patrol officer information. In some embodiments, the workflow generation module 118 may determine the confidence score for each employee based on the determined workflow and its attributes. For example, if the master plan is patrolling a bank building, the sub-master plan can include patrolling a security room for 24 hours with 2 hours shift. In this example, the workflow generation module 118 may identify the attributes, such as the quantitative attributes can include each office with each least 5 years of security patrol experience, more than 95% of successfully completed patrols, having a license to use pistol, having a zero crime record, located within 5 miles from the bank building, and/or with hourly rate less than $200. Further, in this example, the qualitative attributes can include each officer's preference for working patrolling the security area, previous feedback on working at the bank building, knowledge of the regulation, and/or previous customer feedback.

In some embodiments, the workflow generation module 118 can generate a confidence score for assigning each available employee to the available workflows associated with the sub-master plans. For example, after identifying the above attributes, the workflow generation module 118 may generate a low confidence score (or filter out) for the patrol officers who do not meet the quantitative attributes. The workflow generation module 118 may determine the confidence score of the remaining patrol officers based on the qualitative attributes. For example, each attribute of the qualitative attributes can have a different weight, and the confidence score can be determined based on each employee's evaluation based on the qualitative attributes. The weight of each attribute and its determination of the confidence score can be different based on the specific applications.

In some examples, the workflow generation module 118 may transmit the available sub-master plans to the computing devices 102 used by the employees. In various embodiments, the computing device 102 can be configured to receive the available sub-master plans from the workflow generation module 118. In addition, the computing device 102 can provide an interface that can display the available sub-master plans graphically and/or in context. In these embodiments, the employee can monitor the available sub-master plans and select one or more sub-master plans.

In some examples, the workflow generation module 118 may assign the workflow associated with sub-master plans. In some examples, the assignment is based on the determined confidence score.

Some non-limiting examples of machine learning algorithms used for the machine learning module can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), and/or other machine learning algorithms. These machine learning algorithms may include any type of machine learning algorithm, including hierarchical clustering algorithms and cluster analysis algorithms, such as a k-means algorithm. In some cases, the performing of the machine learning algorithms may include the use of an artificial neural network. By using machine-learning techniques, large amounts (such as terabytes or petabytes) of player interaction data may be analyzed to generate models.

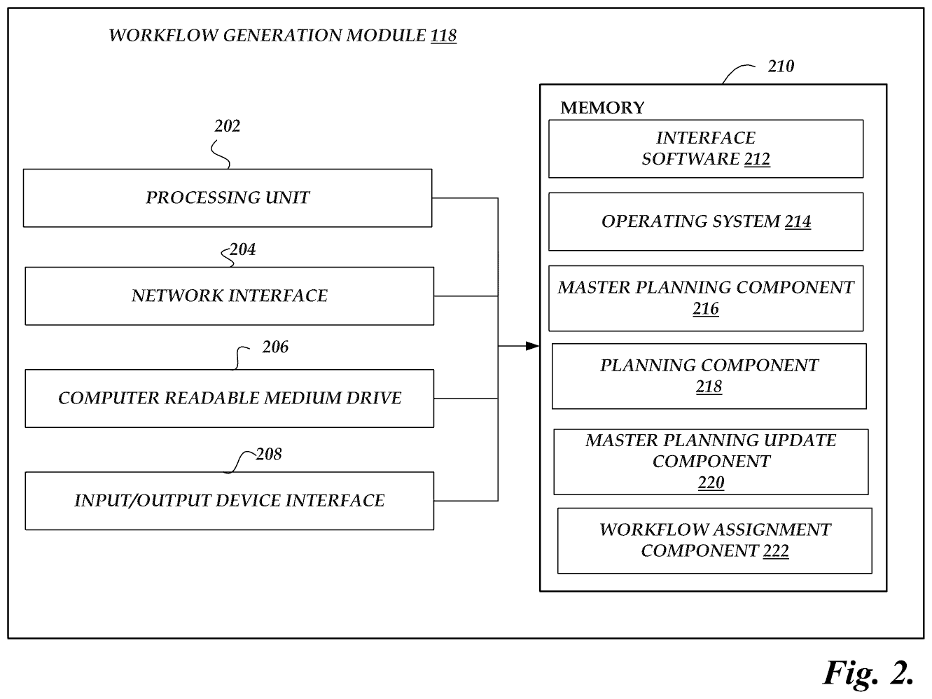

FIG. 2 depicts one embodiment of the architecture of an illustrative workflow generation module 118. The workflow generation module 118 can be designed to assign one or more employees to the workflows. It does this by acquiring workflow requirement data from managing devices 120, identifying the workflows and their corresponding attributes, and then assigning employees to each workflow. The assignment is based on the results of processing the identified attributes of available employees. The general architecture of the workflow generation module 118 depicted in FIG. 2, includes an arrangement of computer hardware and software components that may be used to implement aspects of the present disclosure. As illustrated, the workflow generation module 118 includes a processing unit 202, a network interface 204, a computer-readable medium drive 206, and an input/output device interface 208, all of which may communicate with one another by way of a communication bus. The components of the workflow generation module 118 may be physical hardware components or implemented in a virtualized environment.

The network interface 204 may provide connectivity to one or more networks, such as the networks 104 and 106 of FIG. 1. The processing unit 202 may thus receive information and instructions from other computing systems or services via a network. The processing unit 202 may also communicate to and from memory 210 and further provide output information for an optional display via the input/output device interface 208. In some embodiments, the workflow generation module 118 may include more (or fewer) components than those shown in FIG. 2.

The memory 210 may include computer program instructions that the processing unit 202 executes in order to implement one or more embodiments. The memory 210 generally includes RAM, ROM, or other persistent or non-transitory memory. The memory 210 may store an operating system 214 that provides computer program instructions for use by the processing unit 202 in the general administration and operation of the workflow generation module 118. The memory 210 may further include computer program instructions and other information for implementing aspects of the present disclosure. For example, in one embodiment, the memory 210 includes interface software 212 for communicating with other components or services and performing one or more aspects as disclosed herein.

The memory 210 may include a master planning component 216. In some embodiments, the master planning component 216 can be configured to generate a master plan of workflow by processing workflow requirements received from the managing devices 120. For example, a system administrator (e.g., business operation manager, business administrator, etc.) may provide the workflow requirements to the master planning component 216. In some scenarios, the workflow requirements can be provided as texts or any type of visual representation. In some examples, the master planning component 216 may process the received workflow requirements to generate a master plan. The master plan can vary based on the specific applications. For example, the master plan of the application of security patrol service provider can include attributes of targeted patrol area(s), types of area(s), number of area(s), and the like.

In some embodiments, the master planning component 216 can process the workflow requirements received from the managing devices and generate a hierarchical data structure. For example, if system 100 is implemented by a security patrol service provider, the hierarchical data can include various levels, such that the highest level of the data structure can be a building, the lower layer can be floors, the lower layer can be rooms within the floors, and the lowest layer can be the posts in each room. The master planning component 216 may assign one or more required workflow for each level of the hierarchical data structure. For example, at the highest level, the master planning component 216 may assign attributes of the types of patrol areas, required security level, patrol time, etc. For the purpose of the description, the lowest level of the data structure can be referred to as the sub-master plan. For example, in the sub-master plan, the master planning component 216 may process the lowest level of the data structure by associating it with the required attributes. Further, in this example, if the lowest level of the data structure is posts, each post can be associated with the required patrol attributes for each post, such as the number of patrol officials, patrol time, required capability of the patrol official, and the like.

In some scenarios, the master planning component 216 can vectorize the space of the targeted patrol area. For example, the master planning component 216 can vectorize a targeted patrol building and identify the location and area of the post from the vector. In some examples, a security patrol contract may specify the post area, such as every 100 square feet of the patrol area needs one patrol official during a certain time. In these examples, the master planning component 216 can vectorize the patrol area, and this vectorized area can be utilized to determine the corresponding post area, such as the 100 square feet. Furthermore, the master planning component 216 can identify the number of patrol required officials by identifying the number of post areas based on the vectorized targeted patrol area. For example, if a vectorized size of a building is 10000 square feet, there would be 10 patrol officials needed at the same time slots.

The memory 210 can also include a planning component 218. The planning component 218 can generate run-time workflows for a certain duration of time based on the master plan. For example, the automated run-time workflow assignment system may periodically generate workflows associated with a master plan. The duration of each period can be pre-defined and/or dynamically defined based on specific applications. The present application does not limit the pre-defined duration of each period.

In some embodiments, the planning component 218 can generate workflows associated with a master plan and periodically verify one or more portions of the workflows. The period can be determined as a pre-defined time period. The present disclosure does not limit the pre-defined period, and the duration can be determined based on specific application. For example, the planning component 218 can verify the workflows for a duration of 2 weeks. In this example, the planning component 218 can monitor the workflow attributes and/or the employee attributes that may trigger changes or modifications to the workflows for the duration of 2 weeks. In some examples, the planning component 218 can detect one or more events that can cause the changes in the workflow requirements. For example, the events can relate to the changes in at least one attributes of the workflow and the employee attributes. For instance, the event can be changes of the workflow requirements, such as changes of the patrol areas and required number of patrol officers in each post. In this instance, the planning component 218 can detect the events and modify the workflows based on the detected events.

In various examples, the planning component 218 can assign employees for each workflow. The planning component 218 may assign the employees periodically. In some embodiments, the planning component 218 may assign the employees to each workflow based on the master plan. Then, the planning component 218 may monitor whether one or more events are occurring, and upon detecting the one or events, the planning component 218 can update the existing assigned employees.

In various embodiments, the planning component 218 may assign the employees by identifying the available employees who can work on one or more workflows. In some examples, the planning component 218 can access its database and identify the available employees. For example, if the automated run-time workflow assignment system is used by a security patrol service provider, the database 150 of the automated run-time workflow assignment system may store the employed security patrol officer's information. In some applications, the planning component 218 may receive one or more available employees from the computing device 102. For example, the planning component 218 may transmit the available sub-master plans to the computing devices 102 used by the employees. In various embodiments, the computing device 102 can be configured to receive the available workflows from the planning component 218. In addition, the computing device 102 can provide an interface that can display the available sub-master plans graphically and/or in context. In these embodiments, the employee can monitor the available workflows and select one or more available workflows.

The planning component 218 can also assign the employees by identifying qualified employees from the identified available employees. In some embodiments, the planning component 218 may determine the confidence score for each available employee based on the determined workflow and its attributes. For example, if the master plan is patrolling a bank building, the sub-master plan can include patrolling a security room for 24hours with 2 2-hour shift. In this example, the automated run-time workflow assignment system may identify the attributes, such as the quantitative attributes can include each office with each least 5 years of security patrol experience, more than 95% of successfully completed patrols, having a license to use a pistol, having a zero crime records, located within 5 miles from the bank building, and/or with hourly rate less than $200. Further, in this example, the qualitative attributes can include each officer's preference for working patrolling the security area, previous feedback on working at the bank building, knowledge of the regulation, and/or previous customer feedback.

In this scenario, the planning component 218 can evaluate patrol officers based on certain identified attributes. Officers who fail to meet the quantitative criteria may be assigned a low confidence score or excluded entirely. The planning component 218 then calculates confidence scores for the remaining officers using qualitative attributes. Each qualitative attribute can have a different weight, and the confidence score is determined by evaluating each officer's performance against these attributes. The weight assigned to each attribute and the resulting confidence score can vary depending on the specific application. In some cases, the planning component 218 may calculate confidence scores by weighing each of both quantitative and qualitative attributes. The planning component 218 can also determine which employees are available for each workflow by filtering them based on a threshold confidence score. For instance, the selection of patrol officers for each workflow could be determined by the required confidence score for that workflow. Different workflows may require different confidence scores in some applications. In others, each workflow might have unique attributes and require a distinct threshold confidence score. These workflows, their associated attributes, and required confidence scores can be tailored to suit specific applications.

In certain instances, the planning component 218 might sift through the pool of identified employees using a score-based filter, applying a threshold score that varies according to the specific applications. For instance, in the context of a security patrol area demanding highly proficient officers, the required threshold score would be set higher than in zones where a less rigorous security presence suffices.

In some embodiments, the planning component 218 can further determine employees by further filtering based on a collective performance of each employee. In some examples, the planning component 218 can filter the identified employees based on collective performance data. For example, if the collective performance data indicate that certain employees had poor performance, such as these employees did not come to the work, the automated run-time workflow assignment system may exclude these employees from the pool of identified employees. In some embodiments, the planning component 218 can manage these employees who had poor performance record. For example, the automated run-time workflow assignment system can provide additional incentives to these employees to improve their work performance.

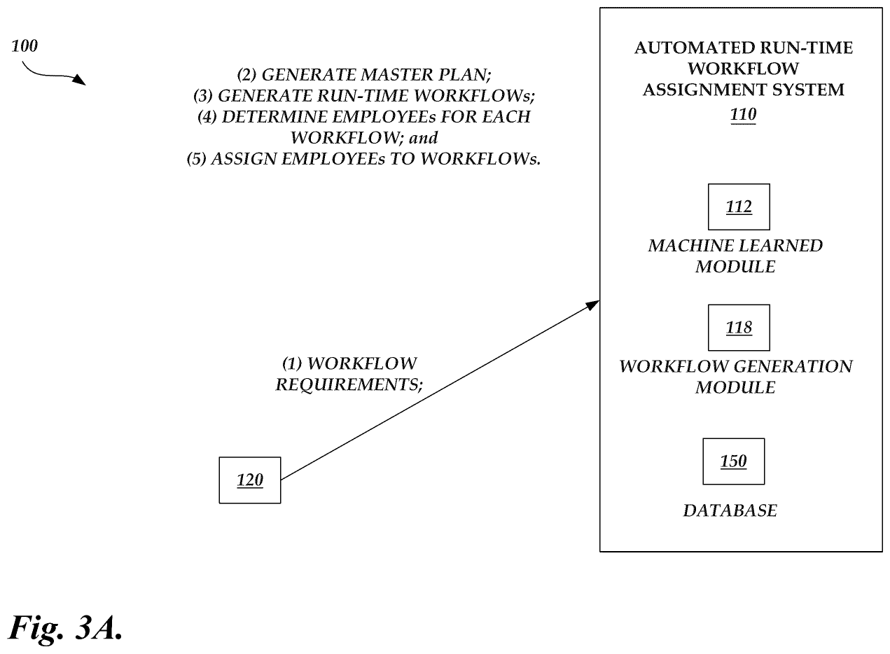

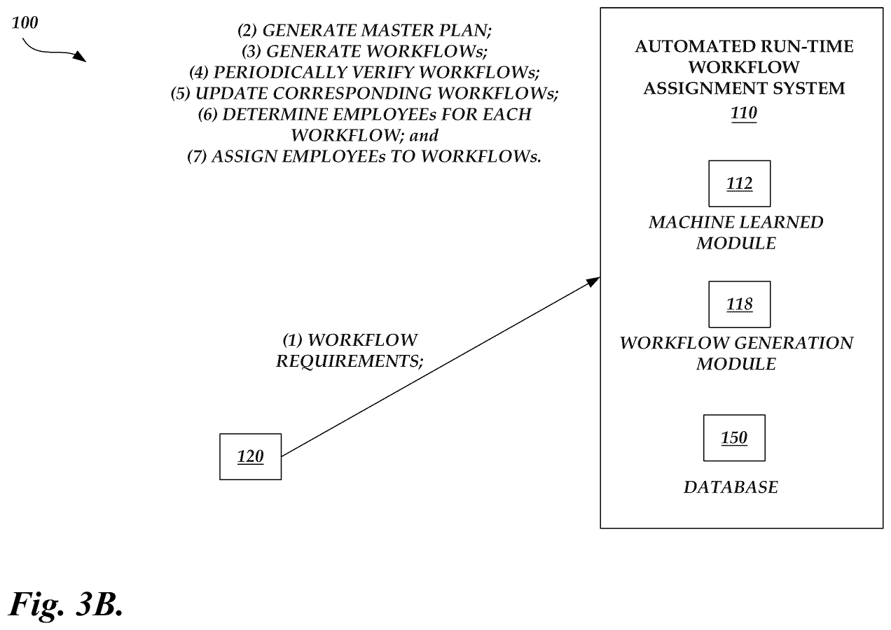

Turning now to FIGS. 3A and 3B, illustrative interactions of the components of the system 100, as shown in FIG. 1, will be described. For purposes of the illustration, it can be assumed that the automated run-time workflow assignment system 110 has been configured in a manner to implement the workflow generation module 118. For the purpose of description, FIGS. 3A and 3B can be described with respect to a security patrol service provider. The present application is not intended to be limited to any particular type of service or the number of individual services that may be accessed or generate processing results as part of the execution of an application.

With reference to FIG. 3A, an illustrative interaction of run-time workflows generation and assigning employees to one or more workflows that can be utilized in the aspects of the automated run-time workflow assignment system 110 will be described. The interaction is illustrative. At (1), a system administrator (e.g., business operation manager, business administrator, etc.) may provide the workflow requirements to the automated run-time workflow assignment system 110 via the managing devices 120. In some scenarios, the workflow requirements can be provided as texts or any type of visual representation or format. For example, if the automated run-time workflow assignment system 110 is implemented for a security patrol service provider, the workflow requirements can be provided as the security patrol service contracts.

At (2), the automated run-time workflow assignment system 110 can generate a master plan. The master plan can define work requirements that can be performed by employees. The master plan can vary based on specific applications. For example, the master plan of the application of security patrol service provider can include attributes of targeted patrol area(s), types of area(s), number of area(s), and the like. In some embodiments, the automated run-time workflow assignment system 110 can process the workflow requirements received from the managing devices and generate a hierarchical data structure. For example, if system 100 is implemented by a security patrol service provider, the hierarchical data can include various levels, such that the highest level of the data structure can be a building, the lower layer can be floors, the lower layer can be rooms within the floors, and the lowest layer can be the posts in each room.

In some scenarios, the automated run-time workflow assignment system 110 can vectorize the space of the targeted patrol area. For example, the automated run-time workflow assignment system 110 can vectorize a targeted patrol building and identify the location and area of the post (e.g., the lowest level of the data structure) from the vector. In some examples, a security patrol contract may specify the post area, such as every 100 square feet of the patrol area needs one patrol official during a certain time. In these examples, the automated run-time workflow assignment system 110 can vectorize the patrol area, and this vectorized area can be utilized to determine the corresponding post area, such as the 100 square feet. Furthermore, the automated run-time workflow assignment system 110 can identify the number of patrol required officials by identifying the number of post areas based on the vectorized targeted patrol area. For example, if a vectorized size of building is 10000 square feet, there would be 10 patrol officials are needed at the same time slot.

In some embodiments, where the security patrol service provider (or certain applications that employee's workflows are related to the time shift) is utilizing the automated run-time workflow assignment system 110, the master plan and/or the sub-master plan can include time slots. For example, the plan can include a targeted patrol area or post and its associated shift time. The shift time can be processed to represent time slots.

At (3), the automated run-time workflow assignment system 110 may generate run-time workflows for a period. More specifically, the automated run-time workflow assignment system 110 can determine one or more required workflows for each level of the hierarchical data structure during a pre-defined period. The duration of each period can be pre-defined and/or dynamically defined based on specific applications. The present application does not limit the pre-defined duration of each period. Illustratively, at the highest level of the master plan, the automated run-time workflow assignment system 110 may determine the workflows based on the types of patrol areas, required security level, patrol time, etc. For the purpose of the description, the lowest level of the data structure can be referred to as a sub-master plan. For example, in the sub-master plan, the automated run-time workflow assignment system 110 may process the lowest level of the data structure by associating it with the required workflows. Further, in this example, if the lowest level of the data structure is posts, each post can be associated with the required patrol workflows for each post, such as the number of patrol officials, patrol time, required capability of the patrol official, and the like. Thus, the automated run-time workflow assignment system 110 can determine the workflows during the pre-defined period of time.

In various embodiments, the automated run-time workflow assignment system 110 can determine attributes for each workflow. In some embodiments, the automated run-time workflow assignment system 110 further processes these sub-master plans and determines attributes associated each sub-master plan. In various instances, the attributes can include quantitative attributes and qualitative attributes. The quantitative attributes, for example, can be related to any attributes related to the sub-master plans that attributes are represented with numbers. For example, in an application of the automated run-time workflow assignment system for the security patrol service provider, the quantitative attributes can include but are not limited to years of experience, number of successful patrols completed, number of incidents resolved, availability of the patrol officer, location of the patrol officer, patrol officer's response time to the incident, rate of the patrol officer, and the like. The qualitative attributes can be identified based on the behavior of the employees, feedback, descriptive information about the employees, etc. For example, the qualitative attributes can include but are not limited to patrol officers' communication skills, decision-making skills, integrity, interpersonal skills, knowledge of the regulations and patrol policy, customer service skills, etc. These attributes are generally from other people's reviews (or descriptions) about the specific patrol official. Additionally, the qualitative attributes can also include the patrol officer's own feedback, opinion, and/or survey results. These quantitative and qualitative attributes are determined based on specific applications, and the present disclosure does not limit the types of attributes.

At (4), the automated run-time workflow assignment system 110 may determine employees for each workflow. In some embodiments, the automated run-time workflow assignment system 110 may identify the available employees who can work on one or more sub-master plans. In some examples, the automated run-time workflow assignment system can access its database and identify the available employees. For example, if the automated run-time workflow assignment system is used by a security patrol service provider, the database of the automated run-time workflow assignment system may store the employed security patrol officer's information. In some applications, the automated run-time workflow assignment system 110 may receive one or more available employees from the computing device 102. For example, the automated run-time workflow assignment system 110 may transmit the available sub-master plans to the computing devices 102 used by the employees. In various embodiments, the computing device 102 can be configured to receive the available sub-master plans from the automated run-time workflow assignment system 110. In addition, the computing device 102 can provide an interface that can display the available sub-master plans graphically and/or in context. In these embodiments, the employee can monitor the available sub-master plans and select one or more sub-master plans.

Further at (4), the automated run-time workflow assignment system 110 can identify qualified employees from the identified available employees. In some embodiments, the automated run-time workflow assignment system 110 may determine the confidence score for each available employee based on the determined workflow and its attributes. For example, if the master plan is patrolling a bank building, the sub-master plan can include patrolling a security room for 24 hours with 2 hours shift. In this example, the automated run-time workflow assignment system may identify the attributes, such as the quantitative attributes can include each office with each least 5 years of security patrol experience, more than 95% of successful completed patrols, having a license to use pistol, having a zero crime records, located within 5 miles from the bank building, and/or with hourly rate less than $200. Further in this example, the qualitative attributes can include each officer's preference for patrolling the security area, previous feedback on working at the bank building, knowledge of the regulation, and/or previous customer feedback.

In this scenario, the automated run-time workflow assignment system 110 can evaluate patrol officers based on certain identified attributes. Officers who fail to meet the quantitative criteria may be assigned a low confidence score or excluded entirely. The automated run-time workflow assignment system 110 then calculates confidence scores for the remaining officers using qualitative attributes. Each qualitative attribute can have a different weight, and the confidence score is determined by evaluating each officer's performance against these attributes. The weight assigned to each attribute and the resulting confidence score can vary depending on the specific application. In some cases, the automated run-time workflow assignment system 110 may calculate confidence scores by weighing each of both quantitative and qualitative attributes. The automated run-time workflow assignment system 110 can also determine which employees are available for each workflow by filtering them based on a threshold confidence score. For instance, the selection of patrol officers for each workflow in the sub-master plan could be determined by the required confidence score for that workflow. Different workflows may require different confidence scores in some applications. In others, each workflow might have unique attributes and require a distinct threshold confidence score. These workflows, their associated attributes, and required confidence scores can be tailored to suit specific applications. In some embodiments, the automated run-time workflow assignment system 110 can utilize the machine learned module 112 to perform portion or all of the step (5).

In certain instances, the automated run-time workflow assignment system might sift through the pool of identified employees using a score-based filter, applying a threshold score that varies according to the specific applications. For instance, in the context of a security patrol area demanding highly proficient officers, the required threshold score would be set higher than in zones where a less rigorous security presence suffices.

In some embodiments, the automated run-time workflow assignment system can further determine employees by further filtering based on a collective performance of each employee. In some examples, the automated run-time workflow assignment system can filter the identified employees based on collective performance data. For example, if the collective performance data indicate that certain employees had poor performance, such as these employees did not come to the work, the automated run-time workflow assignment system may exclude these employees from the pool of identified employees. In some embodiments, the automated run-time workflow assignment system can manage these employees who had poor performance record. For example, the automated run-time workflow assignment system can provide additional incentives to these employees to improve their work performance.

At (5), the automated run-time workflow assignment system 110 can assign the employees to one or more available workflows included in the master plan or sub-master plans. In some embodiments, the assignment is based on the verification by using the confidence score at (5).

With reference to FIG. 3B, an illustrative interaction of workflows generation and assigning employees to one or more workflows that can be utilized in the aspects of the automated run-time workflow assignment system 110 will be described. The interaction is illustrative.

At (1), a system administrator (e.g., business operation manager, business administrator, etc.) may provide the workflow requirements to the automated run-time workflow assignment system 110 via the managing devices 120. In some scenarios, the workflow requirements can be provided as texts or any type of visual representation or format. For example, if the automated run-time workflow assignment system 110 is implemented for a security patrol service provider, the workflow requirements can be provided as the security patrol service contracts.

At (2), the automated run-time workflow assignment system 110 can generate a master plan. The master plan can define work requirements that can be performed by employees. The master plan can vary based on specific applications. For example, the master plan of the application of security patrol service provider can include attributes of targeted patrol area(s), types of area(s), number of area(s), and the like. In some embodiments, the automated run-time workflow assignment system 110 can process the workflow requirements received from the managing devices and generate a hierarchical data structure. For example, if system 100 is implemented by a security patrol service provider, the hierarchical data can include various levels, such that the highest level of the data structure can be a building, the lower layer can be floors, the lower layer can be rooms within the floors, and the lowest layer can be the posts in each room.

At (3), the automated run-time workflow assignment system 110 may determine one or more required workflows for each level of the hierarchical data structure. For example, at the highest level, the automated run-time workflow assignment system 110 may determine the workflows based on the types of patrol areas, required security level, patrol time, etc. For the purpose of the description, the lowest level of the data structure can be referred to as a sub-master plan. For example, in the sub-master plan, the automated run-time workflow assignment system 110 may process the lowest level of the data structure by associating it with the required workflows. Further, in this example, if the lowest level of the data structure is posts, each post can be associated with the required patrol workflows for each post, such as the number of patrol officials, patrol time, required capability of the patrol official, and the like.

In some scenarios, the automated run-time workflow assignment system 110 can vectorize the space of the targeted patrol area. For example, the automated run-time workflow assignment system 110 can vectorize a targeted patrol building and identify the location and area of the post (e.g., the lowest level of the data structure) from the vector. In some examples, a security patrol contract may specify the post area, such as every 100 square feet of the patrol area needs one patrol official during a certain time. In these examples, the automated run-time workflow assignment system 110 can vectorize the patrol area, and this vectorized area can be utilized to determine the corresponding post area, such as the 100 square feet. Furthermore, the automated run-time workflow assignment system 110 can identify the number of patrol required officials by identifying the number of post areas based on the vectorized targeted patrol area. For example, if a vectorized size of the building is 10000 square feet, there would be 10 patrol officials are needed at the same time slot.

In some embodiments, where the security patrol service provider (or certain applications that employee's workflows are related to the time shift) is utilizing the automated run-time workflow assignment system 110, the master plan and/or the sub-master plan can include time slots. For example, the plan can include a targeted patrol area or post and its associated shift time. The shift time can be processed to represent time slots.

In some embodiments, the automated run-time workflow assignment system 110 further processes these sub-master plans and determines attributes associated each sub-master plan. In various instances, the attributes can include quantitative attributes and qualitative attributes. The quantitative attributes, for example, can be related to any attributes related to the sub-master plans that attributes are represented with numbers. For example, in an application of the automated run-time workflow assignment system for the security patrol service provider, the quantitative attributes can include but are not limited to years of experience, number of successful patrols completed, number of incidents resolved, availability of the patrol officer, location of the patrol officer, patrol officer's response time to the incident, rate of the patrol officer, and the like. The qualitative attributes can be identified based on the behavior of the employees, feedback, descriptive information about the employees, etc. For example, the qualitative attributes can include but are not limited to patrol officers' communication skills, decision-making skills, integrity, interpersonal skills, knowledge of the regulations and patrol policy, customer service skills, etc. These attributes are generally from other people's reviews (or descriptions) about the specific patrol official. Additionally, the qualitative attributes can also include the patrol officer's own feedback, opinion, and/or survey results. These quantitative and qualitative attributes are determined based on specific applications, and the present disclosure does not limit the types of attributes.

At (4), the automated run-time workflow assignment system 110 periodically verify one or more portions of the workflows. The period can be determined as a pre-defined time period. The present disclosure does not limit the pre-defined period, and the duration can be determined based on specific application. For example, the automated run-time workflow assignment system 110 can verify the workflows for a duration of 2 weeks. In this example, the automated run-time workflow assignment system 110 can monitor the workflow attributes and/or the employee attributes that may trigger a changes or modifications to the workflows for the duration of 2 weeks. In some examples, the automated run-time workflow assignment system 110 can detects one or more events that can cause changes in the workflow requirements. For example, the events can relate to the changes in at least one attribute of the workflow and the employee attributes. For instance, the event can be changes of the workflow requirements, such as changes of the patrol areas and the required number of patrol officers in each post. At (5), the automated run-time workflow assignment system 110 can modify the workflows based on the detected events.

At (6), the automated run-time workflow assignment system 110 may determine employees for each workflow. In some embodiments, the automated run-time workflow assignment system 110 may identify the available employees who can work on one or more sub-master plans. In some examples, the automated run-time workflow assignment system can access its database and identify the available employees. For example, if the automated run-time workflow assignment system is used by a security patrol service provider, the database of the automated run-time workflow assignment system may store the employed security patrol officer's information. In some applications, the automated run-time workflow assignment system 110 may receive the one or more available employees from the computing device 102. For example, the automated run-time workflow assignment system 110 may transmit the available sub-master plans to the computing devices 102 used by the employees. In various embodiments, the computing device 102 can be configured to receive the available sub-master plans from the automated run-time workflow assignment system 110. In addition, the computing device 102 can provide an interface that can display the available sub-master plans graphically and/or in context. In these embodiments, the employee can monitor the available sub-master plans and select one or more sub-master plans.

Further at (6), the automated run-time workflow assignment system 110 can identify qualified employees from the identified available employees. In some embodiments, the automated run-time workflow assignment system 110 may determine confidence score for each available employee based on the determined workflow and its attributes. For example, if the master plan is patrolling a bank building, the sub-master plan can include patrolling a security room for 24 hours with 2 hours shift. In this example, the automated run-time workflow assignment system may identify the attributes, such as the quantitative attributes can include each office with each least 5 years of security patrol experience, more than 95% of successfully completed patrols, having a license to use a pistol, having a zero crime records, located within 5 miles from the bank building, and/or with hourly rate less than $200. Further, in this example, the qualitative attributes can include each officer's preference for patrolling the security area, previous feedback on working at the bank building, knowledge of the regulation, and/or previous customer feedback.

In this scenario, the automated run-time workflow assignment system 110 can evaluate patrol officers based on certain identified attributes. Officers who fail to meet the quantitative criteria may be assigned a low confidence score or excluded entirely. The automated run-time workflow assignment system 110 then calculates confidence scores for the remaining officers using qualitative attributes. Each qualitative attribute can have a different weight, and the confidence score is determined by evaluating each officer's performance against these attributes. The weight assigned to each attribute and the resulting confidence score can vary depending on the specific application. In some cases, the automated run-time workflow assignment system 110 may calculate confidence scores by weighing each of both quantitative and qualitative attributes. The automated run-time workflow assignment system 110 can also determine which employees are available for each workflow by filtering them based on a threshold confidence score. For instance, the selection of patrol officers for each workflow in the sub-master plan could be determined by the required confidence score for that workflow. Different workflows may require different confidence scores in some applications. In others, each workflow might have unique attributes and require a distinct threshold confidence score. These workflows, their associated attributes, and required confidence scores can be tailored to suit specific applications. In some embodiments, the automated run-time workflow assignment system 110 can utilize the machine learned module 112 to perform a portion or all of the step (6).

At (7), the automated run-time workflow assignment system 110 can assign the employees to one or more available workflows included in the master plan or sub-master plans. In some embodiments, the assignment is based on the verification by using the confidence score.

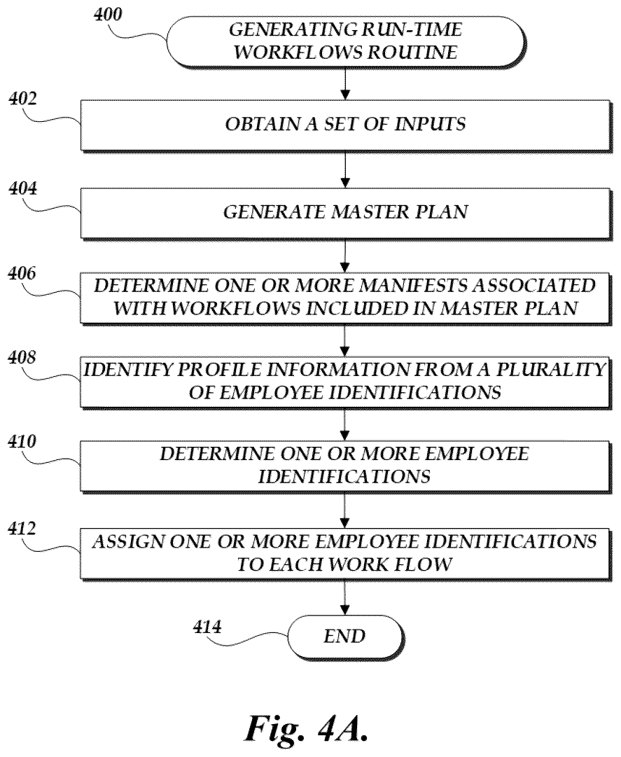

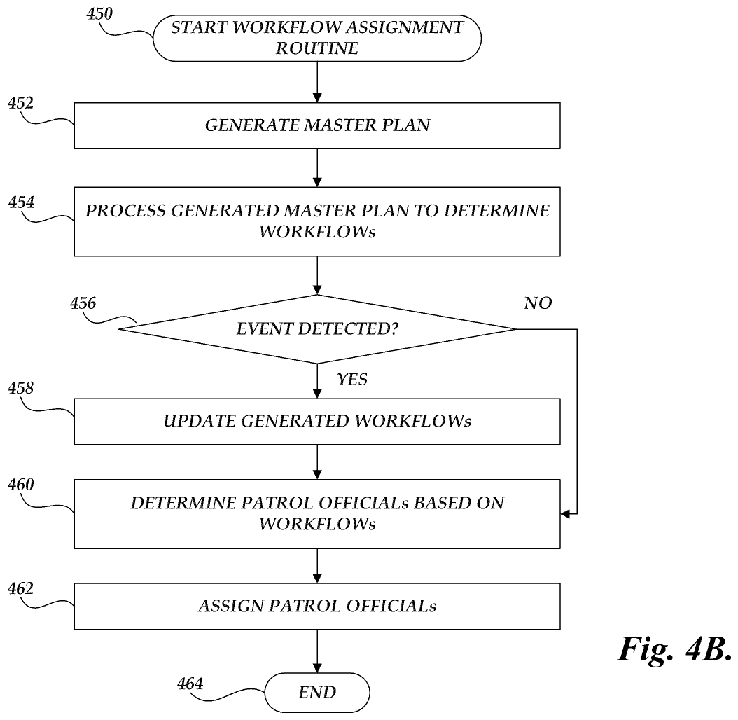

FIG. 4A describes a routine 400 for generating run-time workflows. The routine 400 can correspond to the illustrative interaction described in FIG. 3A. For the purpose of illustration, the routine 400 can be performed by the automated run-time workflow assignment system 110 provided by a network service provider.

At block 402, the automated run-time workflow assignment system 110 obtains a set of inputs from a database 150 included in the automated run-time workflow assignment system. In some examples, the set of inputs includes a set of target areas, and each

target area includes a plurality of sub-areas. At block 404, the automated run-time workflow assignment system 110 generates, by utilizing a machine learning component stored in the memory 210, a master plan based on the set of inputs. In some examples, the master plan includes a set of hierarchical data, and the hierarchical data can include a plurality of layers, where each layer is associated with one or more vectorized sub-areas and associated workflows. In some cases, the machine learning component is stored in the memory as a module. In some examples, the master plan includes vectorized identifications of each of the plurality of sub-areas and workflows for each identified sub-area, and the machine learning component includes a neural network model configured to collect, from a historical data stored in a database, a historical plurality of sub-areas and historical workflows associated with each sub-area of the historical plurality of sub-areas, apply the historical data the neural network model, generate a set of workflows associated with the historical data, train the neural network model by updating neural network parameters by comparing the generated set of workflows associated with the historical plurality of sub-areas and the historical workflows associated with each sub-area of the historical plurality of sub-areas, and generate the workflows associated to each vectorized identified sub-area. In some examples, the workflows are patrolling a patrol area, where a top level of the hierarchical data is patrolling the patrol area, having a plurality of posts, wherein a lower level of the hierarchical data is a patrolling plan of each post of the plurality of posts. In some cases, the automated run-time workflow assignment system is configured to periodically updates the master plan, and the master plan can include a number of demanded employees for each workflow.

At block 406, the automated run-time workflow assignment system 110 determines, by accessing the database 150, one or more manifests associated with the identified workflow. In some examples, the manifest of each identified workflow includes location information and time information. In various embodiments, the database 150 can be configured to store a plurality of manifests associated with a plurality of workflows.

At block 408, the automated run-time workflow assignment system 110 accesses the database 150 to identify profile information of a plurality of employee identifications. In some examples, the profile information comprising geometry identifiers and time identifiers of each of the plurality of employee identifications. In some examples, the automated run-time workflow assignment system is communicatively coupled with one or more employee computing devices, and each employee is configured to manage corresponding profile information by accessing the database via associated employee computing device.

At block 410, the automated run-time workflow assignment system 110 determines, for each vectorized sub-area, one or more employee identifications by comparing the geometry and time identifiers of each of the plurality of employees with the location information and time information included in the manifest of each workflow.

At block 412, the automated run-time workflow assignment system 110 assigns each workflow to identified corresponding one or more employee identifications. In some embodiments, the neural network model is configured to assign the identified employee identifications to the workflows by collecting, from the database, a set of attributes of each of the identified employee identifications, where the set of attributes include quantitative attributes and qualitative attributes, vectorizing each of the quantitative attributes and qualitative attributes, applying the vectorized quantitative attributes and qualitative attributes to the neural network model, generating, for each identified employee identification, a confidence score by applying the vectorized quantitative attributes and the qualitative attributes to the neural network model, prioritizing, for each workflow, the identified employee identifications based on the confidence score of each of the identified employee identifications, and assigning the identified employee identifications to the workflows based on prioritization results. In some cases, the machine learning component is further configured to dynamically assign the identified employee identifications to the workflows by dynamically updating the quantitative attributes and qualitative attributes of the identified employees. In various embodiments, the automated run-time workflow assignment system is configured monitor the confidence score.

In some embodiments, the automated run-time workflow assignment system is further configured receive the set of inputs from an external computing device. Additionally, the automated run-time workflow assignment system is further configured to authenticate the external computing device by receiving an application program interface token from the external computing device and verifying the received application program interface token. The routine 400 can end at block 414.

Although the operations of the routine 400 are described in a particular order, it should be understood that the routine 400 is not limited as such. Operations of the routine 400 may be performed in an alternative order, serially, or at least partially in parallel. Further, certain operations may not need to be performed. For example, operations associated with the block 406 and block 408 may be performed in parallel.

Although the operations of the routine 400 are described in a particular order, it should be understood that the routine 400 is not limited as such. Operations of the routine 400 may be performed in an alternative order, serially, or at least partially in parallel. Further, certain operations may not need to be performed.

FIG. 4B describes a routine 450 for generating run-time workflows. The routine 450 can correspond to the illustrative interaction described in FIG. 3B.

At block 452, a system administrator (e.g., business operation manager, business administrator, etc.) may provide the workflow requirements to the automated run-time workflow assignment system 110 via the managing devices 120. In some scenarios, the workflow requirements can be provided as texts or any type of visual representation or format. For example, if the automated run-time workflow assignment system 110 is implemented for a security patrol service provider, the workflow requirements can be provided as the security patrol service contracts.

At block 454, the automated run-time workflow assignment system 110 can generate a master plan. The master plan can define work requirements that can be performed by employees. The master plan can vary based on specific applications. For example, the master plan of the application of security patrol service provider can include attributes of targeted patrol area(s), types of area(s), number of area(s), and the like. In some embodiments, the automated run-time workflow assignment system 110 can process the workflow requirements received from the managing devices and generate a hierarchical data structure. For example, if system 100 is implemented by a security patrol service provider, the hierarchical data can include various levels, such that the highest level of the data structure can be a building, the lower layer can be floors, the lower layer can be rooms within the floors, and the lowest layer can be the posts in each room.

Further at block 454, the automated run-time workflow assignment system 110 may determine one or more required workflows for each level of the hierarchical data structure. For example, at the highest level, the automated run-time workflow assignment system 110 may determine the workflows based on the types of patrol areas, required security level, patrol time, etc. For the purpose of the description, the lowest level of the data structure can be referred to as a sub-master plan. For example, in the sub-master plan, the automated run-time workflow assignment system 110 may process the lowest level of the data structure by associating it with the required workflows. Further, in this example, if the lowest level of the data structure is posts, each post can be associated with the required patrol workflows for each post, such as the number of patrol officials, patrol time, required capability of the patrol official, and the like.

In some scenarios, the automated run-time workflow assignment system 110 can vectorize the space of the targeted patrol area. For example, the automated run-time workflow assignment system 110 can vectorize a targeted patrol building and identify the location and area of the post (e.g., the lowest level of the data structure) from the vector. In some examples, a security patrol contract may specify the post area, such as every 100 square feet of the patrol area needs one patrol official during a certain time. In these examples, the automated run-time workflow assignment system 110 can vectorize the patrol area, and this vectorized area can be utilized to determine the corresponding post area, such as the 100 square feet. Furthermore, the automated run-time workflow assignment system 110 can identify the number of patrol required officials by identifying the number of post areas based on the vectorized targeted patrol area. For example, if a vectorized size of the building is 10000 square feet, there would be 10 patrol officials are needed at the same time slot.

In some embodiments, where the security patrol service provider (or certain applications that employee's workflows are related to the time shift) is utilizing the automated run-time workflow assignment system 110, the master plan and/or the sub-master plan can include time slots. For example, the plan can include a targeted patrol area or post and its associated shift time. The shift time can be processed to represent time slots.

In some embodiments, the automated run-time workflow assignment system 110 further processes these sub-master plans and determines attributes associated each sub-master plan. In various instances, the attributes can include quantitative attributes and qualitative attributes. The quantitative attributes, for example, can be related to any attributes related to the sub-master plans that attributes are represented with numbers. For example, in an application of the automated run-time workflow assignment system for the security patrol service provider, the quantitative attributes can include but are not limited to years of experience, number of successful patrols completed, number of incidents resolved, availability of the patrol officer, location of the patrol officer, patrol officer's response time to the incident, rate of the patrol officer, and the like. The qualitative attributes can be identified based on the behavior of the employees, feedback, descriptive information about the employees, etc. For example, the qualitative attributes can include but are not limited to patrol officers' communication skills, decision-making skills, integrity, interpersonal skills, knowledge of the regulations and patrol policy, customer service skills, etc. These attributes are generally from other people's reviews (or descriptions) about the specific patrol official. Additionally, the qualitative attributes can also include the patrol officer's own feedback, opinion, and/or survey results. These quantitative and qualitative attributes are determined based on specific applications, and the present disclosure does not limit the types of attributes.

At block 456, the automated run-time workflow assignment system 110 determine whether an event is detected. In some examples, the automated run-time workflow assignment system 110 periodically verify one or more portions of the workflows. The period can be determined as a pre-defined time period. The present disclosure does not limit the pre-defined period, and the duration can be determined based on specific application. For example, the automated run-time workflow assignment system 110 can verify the workflows for a duration of 2 weeks. In this example, the automated run-time workflow assignment system 110 can monitor the workflow attributes and/or the employee attributes that may trigger a changes or modifications to the workflows for the duration of 2 weeks. In some examples, the automated run-time workflow assignment system 110 can detects one or more events that can cause the changes in the workflow requirements. For example, the events can relate to the changes in at least one attributes of the workflow and the employee attributes. For instance, the event can be changes of the workflow requirements, such as changes of the patrol areas and required number of patrol officers in each post. If the event is detected the routine 450 proceed to block 458. If no event is detected, the routine proceed to block 460.

At block 458, the automated run-time workflow assignment system 110 can modify the workflows based on the detected events.

At block 460, the automated run-time workflow assignment system 110 may determine employees for each workflow. In some embodiments, the automated run-time workflow assignment system 110 may identify the available employees who can work on one or more sub-master plans. In some examples, the automated run-time workflow assignment system can access its database and identify the available employees. For example, if the automated run-time workflow assignment system is used by a security patrol service provider, the database of the automated run-time workflow assignment system may store the employed security patrol officer's information. In some applications, the automated run-time workflow assignment system 110 may receive the one or more available employees from the computing device 102. For example, the automated run-time workflow assignment system 110 may transmit the available sub-master plans to the computing devices 102 used by the employees. In various embodiments, the computing device 102 can be configured to receive the available sub-master plans from the automated run-time workflow assignment system 110. In addition, the computing device 102 can provide an interface that can display the available sub-master plans graphically and/or in context. In these embodiments, the employee can monitor the available sub-master plans and select one or more sub-master plans.

Further, at block 460, the automated run-time workflow assignment system 110 can identify qualified employees from the identified available employees. In some embodiments, the automated run-time workflow assignment system 110 may determine the confidence score for each available employee based on the determined workflow and its attributes. For example, if the master plan is patrolling a bank building, the sub-master plan can include patrolling a security room for 24 hours with 2 hours shift. In this example, the automated run-time workflow assignment system may identify the attributes, such as the quantitative attributes can include each office with each least 5 years of security patrol experience, more than 95% of successfully completed patrols, having a license to use a pistol, having a zero crime records, located within 5 miles from the bank building, and/or with hourly rate less than $200. Further in this example, the qualitative attributes can include each officer's preference for patrolling the security area, previous feedback on working at the bank building, knowledge of the regulation, and/or previous customer feedback.

In this scenario, the automated run-time workflow assignment system 110 can evaluate patrol officers based on certain identified attributes. Officers who fail to meet the quantitative criteria may be assigned a low confidence score or excluded entirely. The automated run-time workflow assignment system 110 then calculates confidence scores for the remaining officers using qualitative attributes. Each qualitative attribute can have a different weight, and the confidence score is determined by evaluating each officer's performance against these attributes. The weight assigned to each attribute and the resulting confidence score can vary depending on the specific application. In some cases, the automated run-time workflow assignment system 110 may calculate confidence scores by weighing each of both quantitative and qualitative attributes. The automated run-time workflow assignment system 110 can also determine which employees are available for each workflow by filtering them based on a threshold confidence score. For instance, the selection of patrol officers for each workflow in the sub-master plan could be determined by the required confidence score for that workflow. Different workflows may require different confidence scores in some applications. In others, each workflow might have unique attributes and require a distinct threshold confidence score. These workflows, their associated attributes, and required confidence scores can be tailored to suit specific applications. In some embodiments, the automated run-time workflow assignment system 110 can utilize the machine learned module 112 to perform portion or all of the block 460.

In certain instances, the automated run-time workflow assignment system might sift through the pool of identified employees using a score-based filter, applying a threshold score that varies according to the specific applications. For instance, in the context of a security patrol area demanding highly proficient officers, the required threshold score would be set higher than in zones where a less rigorous security presence suffices.

In some embodiments, the automated run-time workflow assignment system can further determine employees by further filtering based on a collective performance of each employee. In some examples, the automated run-time workflow assignment system can filter the identified employees based on collective performance data. For example, if the collective performance data indicate that certain employees had poor performance, such as these employees did not come to the work, the automated run-time workflow assignment system may exclude these employees from the pool of identified employees. In some embodiments, the automated run-time workflow assignment system can manage these employees who had poor performance record. For example, the automated run-time workflow assignment system can provide additional incentives to these employees to improve their work performance.

At block 462, the automated run-time workflow assignment system 110 can assign the employees to one or more available workflows included in the master plan or sub-master plans. In some embodiments, the assignment is based on the verification by using the confidence score at block 460. The routine 450 can be ended at block 464.

Although the operations of the routine 450 are described in a particular order, it should be understood that the routine 400 is not limited as such. Operations of the routine 450 may be performed in an alternative order, serially, or at least partially in parallel. Further, certain operations may not need to be performed. For example, operations associated with the block 406 and block 408 may be performed in parallel.

Although the operations of the routine 450 are described in a particular order, it should be understood that the routine 450 is not limited as such. Operations of the routine 400 may be performed in an alternative order, serially, or at least partially in parallel. Further, certain operations may not need to be performed.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of customer computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable customer computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without customer input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed:

1. A system for dynamically providing workflow assignments, the system comprising:
one or more computing devices associated with a processor and a memory for executing computer-executable instructions to implement an automated run-time workflow assignment system, wherein the automated run-time workflow assignment system is configured to:
obtain a set of inputs from a database included in the automated run-time workflow assignment system, the set of inputs comprising a set of target areas, each target area comprising a plurality of sub-areas;
generate, by utilizing a machine learning component stored in the memory, a master plan based on the set of inputs, wherein the master plan includes vectorized identifications of each of the plurality of sub-areas and workflows for each identified sub-area, and wherein the machine learning component comprises a neural network model configured to:
collect, from a historical data stored in a database, a historical plurality of sub-areas and historical workflows associated with each sub-area of the historical plurality of sub-areas,
apply the historical data the neural network model,
generate a set of workflows associated with the historical data,
train the neural network model by updating neural network parameters by comparing the generated set of workflows associated with the historical plurality of sub-areas and the historical workflows associated with each sub-area of the historical plurality of sub-areas, and
generate the workflows associated to each vectorized identified sub-area,
determine, by accessing the database, one or more manifests associated with the identified workflow, the manifest of each identified workflow comprising location information and time information, the database configured to store a plurality of manifests associated with a plurality of workflows;
access the database to identify profile information of a plurality of employee identifications, the profile information comprising geometry identifiers and time identifiers of each of the plurality of employee identifications;
determine, for each vectorized sub-area, one or more employee identifications by comparing the geometry and time identifiers of each of the plurality of employees with the location information and time information included in the manifest of each workflow; and
assign each workflow to identified corresponding one or more employee identifications.

2. The system of claim 1, wherein the master plan comprise a set of hierarchical data, the hierarchical data comprising a plurality of layers, each layer associated with one or more vectorized sub-areas and associated workflows.

3. The system of claim 2, wherein the workflows are patrolling a patrol area, wherein a top level of the hierarchical data is patrolling the patrol area, having a plurality of posts, wherein a lower level of the hierarchical data is a patrolling plan of each post of the plurality of posts.

4. The system of claim 1, wherein the neural network model is configured to assign the identified employee identifications to the workflows by:
collecting, from the database, a set of attributes of each of the identified employee identifications, the set of attributes comprising quantitative attributes and qualitative attributes,
vectorizing each of the quantitative attributes and qualitative attributes,
applying the vectorized quantitative attributes and qualitative attributes to the neural network model,
generating, for each identified employee identification, a confidence score by applying the vectorized quantitative attributes and the qualitative attributes to the neural network model,
prioritizing, for each workflow, the identified employee identifications based on the confidence score of each of the identified employee identifications, and
assigning the identified employee identifications to the workflows based on prioritization results.

5. The system of claim 4, wherein the machine learning component is further configured to dynamically assign the identified employee identifications to the workflows by dynamically updating the quantitative attributes and qualitative attributes of the identified employees.

6. The system of claim 4, wherein the automated run-time workflow assignment system is configured monitor the confidence score.

7. The system of claim 1, wherein the automated run-time workflow assignment system is further configured receive the set of inputs from an external computing device.

8. The system of claim 7, wherein the automated run-time workflow assignment system is further configured to authenticate the external computing device by receiving an application program interface token from the external computing device and verifying the received application program interface token.

9. The system of claim 1, wherein the automated run-time workflow assignment system is communicatively coupled with one or more employee computing devices, and wherein each employee is configured to manage corresponding profile information by accessing the database via associated employee computing device.

10. The system of claim 1, wherein the automated run-time workflow assignment system is configured to periodically updates the master plan.

11. The system of claim 1, wherein the master plan comprises a number of demanded employees for each workflow.

12. A system for dynamically providing workflow assignments, the system comprising:
one or more computing devices associated with a processor and a memory for executing computer-executable instructions to implement an automated run-time workflow assignment system, wherein the automated run-time workflow assignment system is configured to:
obtain a set of inputs from a database included in the automated run-time workflow assignment system, the set of inputs comprising a set of target areas, each target area comprising a plurality of sub-areas;
generate a master plan based on the set of inputs, wherein the master plan includes vectorized identifications of each of the plurality of sub-areas and workflows for each identified sub-area;
determine, by accessing the database, one or more manifests associated with the identified workflow, the manifest of each identified workflow comprising location information and time information, the database configured to store a plurality of manifests associated with a plurality of workflows;
access the database to identify profile information of a plurality of employee identifications, the profile information comprising geometry identifiers and time identifiers of each of the plurality of employee identifications;
determine, for each vectorized sub-area, one or more employee identifications by comparing the geometry and time identifiers of each of the plurality of employees with the location information and time information included in the manifest of each workflow; and
assign each workflow to identified corresponding one or more employee identifications.

13. The system of claim 12, wherein the master plan comprise a set of hierarchical data, the hierarchical data comprising a plurality of layers, each layer associated with one or more vectorized sub-areas and associated workflows.

14. The system of claim 13, wherein the workflows are patrolling a patrol area, wherein a top level of the hierarchical data is patrolling the patrol area, having a plurality of posts, wherein a lower level of the hierarchical data is a patrolling plan of each post of the plurality of posts.

15. The system of claim 12, wherein the automated run-time workflow assignment system comprises a neural network model stored in the memory, the neural network model configured to assign the identified employee identifications to the workflows by:
collecting, from the database, a set of attributes of each of the identified employee identifications, the set of attributes comprising quantitative attributes and qualitative attributes,
vectorizing each of the quantitative attributes and qualitative attributes,
applying the vectorized quantitative attributes and qualitative attributes to the neural network model,
generating, for each identified employee identification, a confidence score by applying the vectorized quantitative attributes and the qualitative attributes to the neural network model,
prioritizing, for each workflow, the identified employee identifications based on the confidence score of each of the identified employee identifications, and
assigning the identified employee identifications to the workflows based on prioritization results.

16. The system of claim 15, wherein the neural network model is further configured to dynamically assign the identified employee identifications to the workflows by dynamically updating the quantitative attributes and qualitative attributes of the identified employees.

17. The system of claim 15, wherein the automated run-time workflow assignment system is configured monitor the confidence score.

18. The system of claim 12, wherein the automated run-time workflow assignment system is further configured receive the set of inputs from an external computing device.

19. A method of dynamically assigning one or more workflows to employees, the method comprising:
obtaining a set of inputs from a database, the set of inputs comprising a set of target areas, each target area comprising a plurality of sub-areas;
generating, by utilizing a machine learning component, a master plan based on the set of inputs, wherein the master plan includes vectorized identifications of each of the plurality of sub-areas and workflows for each identified sub-area, and wherein the machine learning component comprises a neural network model configured to:
collect, from a historical data stored in a database, a historical plurality of sub-areas and historical workflows associated with each sub-area of the historical plurality of sub-areas,
apply the historical data the neural network model,
generate a set of workflows associated with the historical data,
train the neural network model by updating neural network parameters by comparing the generated set of workflows associated with the historical plurality of sub-areas and the historical workflows associated with each sub-area of the historical plurality of sub-areas, and
generate the workflows associated to each vectorized identified sub-area,
determining, by accessing the database, one or more manifests associated with the identified workflow, the manifest of each identified workflow comprising location information and time information, the database configured to store a plurality of manifests associated with a plurality of workflows;
accessing the database to identify profile information of a plurality of employee identifications, the profile information comprising geometry identifiers and time identifiers of each of the plurality of employee identifications;
determining, for each vectorized sub-area, one or more employee identifications by comparing the geometry and time identifiers of each of the plurality of employees with the location information and time information included in the manifest of each workflow; and
assigning each workflow to identified corresponding one or more employee identifications.

20. The method of claim 19, wherein the machine learning model is configured to assign each workflow to the identified corresponding one or more employee identifications by:
collecting, from the database, a set of attributes of each of the identified employee identifications, the set of attributes comprising quantitative attributes and qualitative attributes,
vectorizing each of the quantitative attributes and qualitative attributes,
applying the vectorized quantitative attributes and qualitative attributes to the neural network model,
generating, for each identified employee identification, a confidence score by applying the vectorized quantitative attributes and the qualitative attributes to the neural network model,
prioritizing, for each workflow, the identified employee identifications based on the confidence score of each of the identified employee identifications, and
assigning the identified employee identifications to the workflows based on prioritization results.
